(19) United States
(12) Patent Application Publication
(10) Pub. No.: US 2014/0357747 A1
(43) Pub. Date: Dec. 4, 2014

(54) FOAM EXPANSION AGENT COMPOSITIONS CONTAINING Z-1,1,1,4,4,4-HEXAFLUORO-2-BUTENE AND THEIR USES IN THE PREPARATION OF POLYURETHANE AND POLYISOCYANURATE POLYMER FOAMS

(71) Applicant: E I DU PONT DE NEMOURS AND COMPANY, Wilmington, DE (US)

(72) Inventors: Gary Loh, Newark, DE (US); Joseph Anthony Creazzo, Wilmington, DE (US)

(73) Assignee: E I DU PONT DE NEMOURS AND COMPANY, Wilmington, DE (US)

(21) Appl. No.: 14/361,927

(22) PCT Filed: Nov. 12, 2012
(86) PCT No.: PCT/US12/64627

§ 371 Date: May 30, 2014

Related U.S. Application Data
(60) Provisional application No. 61/566,182, filed on Dec. 2, 2011.

(51) Int. Cl. C08J 9/14; C08G 18/72; C08G 18/48; C08G 18/08

(52) U.S. Cl. CPC C08J 9/149; C08G 18/14; C08G 18/72; C08G 18/4825; C08G 18/4879; C08J 9/146; C08J 9/141; C08J 2203/162; C08J 2203/182; C08J 2203/14; C08J 2375/08; C08J 2205/052
USPC 521/131; 521/170; 516/12

(57) ABSTRACT

A foam expansion agent composition is disclosed that includes Z-1,1,1,4,4,4-hexafluoro-2-butene and at least one high boiling point foam expansion agent present in an effective amount sufficient to produce a foam having a k-factor less than the k-factor of a foam produced using Z-1,1,1,4,4,4-hexafluoro-2-butene or the at least one high boiling point foam expansion agent alone at a given temperature. Also disclosed is a foam-forming composition that includes the foam expansion agent composition of this disclosure and an active hydrogen-containing compound having two or more active hydrogens. Also disclosed is a closed-cell polyurethane or polyisocyanurate polymer foam prepared from reaction of an effective amount of the foam-forming composition of this disclosure and a suitable polyisocyanate. Also disclosed is a process for producing a closed-cell polyurethane or polyisocyanurate polymer foam. The process involves reacting an effective amount of the foam-forming composition of this disclosure and a suitable polyisocyanate.

### FIELD OF THE INVENTION

The disclosure herein relates to foam expansion agents and their use in the preparation of polyurethane and polyisocyanurate foams. More particularly, the disclosure herein relates to foam expansion agent compositions comprising a Z-1,1,1,4,4,4-hexafluoro-2-butene (also known as Z-FC-1336mzz or Z-FO-1336mzz) and at least one high boiling point expansion agent in an amount sufficient to lower the k-factor of the resultant foam at low temperatures, the foam-forming compositions containing such foam expansion agent compositions, the preparation of polyurethane and polyisocyanurate foams using such foam-forming compositions, and the use of so prepared polyurethane and polyisocyanurate foams.

### BACKGROUND OF THE INVENTION

Closed-cell polyurethane and polyisocyanurate polymer foams are widely used for insulation purposes, for example, in building construction and in the manufacture of energy efficient electrical appliances. In the construction industry, polyurethane/polyisocyanurate board stock is used in roofing and siding for its insulation and load-carrying capabilities. Poured and sprayed polyurethane foams are widely used for a variety of applications including insulating roofs, insulating large structures such as storage tanks, insulating appliances such as refrigerators and freezers, insulating refrigerated trucks and railcars, etc. The insulation performance of a closed-cell polyurethane or polyisocyanurate polymer foam is mainly determined by the thermal conductivity of the cell gas.

In the industry, the insulation performance of a polymer foam is represented by the R-value, a measure of thermal resistance, and the k-factor, a measure of thermal conductivity. Higher R-values, which are measured in units of ft²·h·° F./Btu, indicate a good insulator, whereas low R-values indicate a poor insulator. Conversely, an insulation having a lower k-factor, measured in units of Btu·in/ft²·h·° F., is a better insulator than insulation having a higher k-factor is a better insulator. For flat insulation of a given thickness, the k-factor is inversely proportional to the R-value.

All of these various types of polyurethane/polyisocyanurate foams require foam expansion agents (also known as blowing agents) for their manufacture. Insulating foams depend on the use of halocarbon foam expansion agents, not only to foam the polymer, but primarily for their low vapor thermal conductivity, a very important characteristic for insulation value. For example, hydrofluorocarbons (HFCs) have been employed as foam expansion agents for polyurethane foams. An example of an HFC employed in this application is HFC-245fa (1,1,1,3,3-pentafluoropropane). However, the HFCs are of concern due to their contribution to the “greenhouse effect”, i.e., they contribute to global warming. As a result of their contribution to global warming, the HFCs have come under scrutiny, and their widespread use may also be limited in the future.

Hydrocarbons have also been proposed as foam expansion agents. However, these compounds are flammable, and many are photochemically reactive, and as a result contribute to the production of ground level ozone (i.e., smog). Such compounds are typically referred to as volatile organic compounds (VOCs), and are subject to environmental regulations.

The boiling point of a foam expansion agent can affect the insulation performance of the resulting polymer foam. A high boiling point foam expansion agent may condense in the cell and lose its insulation effectiveness at low temperature. Normally, a foam expansion agent with a high boiling point condenses more severely at low temperatures and causes poorer insulation performance (i.e., lower R-value or higher k-factor) of the polymer foam at low temperature applications.

Z-1,1,1,4,4,4-hexafluoro-2-butene produces foams having desirable k-factors when used as a foam expansion agent in a polyurethane foam or a polyisocyanurate foam. Z-1,1,1,4,4,4-hexafluoro-2-butene has a normal boiling point of 91.4° F. (33° C.). As shown in FIG. 1, the k-factor exhibits a local minimum and increases at both higher and lower temperatures.

When insulation foams are used at relatively low temperatures, such as, for example, in refrigerators or freezers, it may be desirable to use a foam expansion agent composition that is a good insulator that mitigates the condensation effect. For example, it may be desirable to have a foam expansion agent composition comprising Z-1,1,1,4,4,4-hexafluoro-2-butene to produce foams that maintain a lower k-factor at lower temperatures.

### SUMMARY OF THE INVENTION

This disclosure provides a foam expansion agent composition comprising (a) Z-1,1,1,4,4,4-hexafluoro-2-butene; and (b) at least one high boiling point foam expansion agent, wherein the at least one high boiling point foam expansion agent has a boiling point greater than 15° C., wherein the at least one high boiling point foam expansion agent is present in an effective amount sufficient to produce a foam having a lower k-factor at a given temperature than the k-factor of a foam produced using Z-1,1,1,4,4,4-hexafluoro-2-butene alone and a foam produced using the at least one high boiling point foam expansion agent alone.

This disclosure also provides a foam-forming composition comprising the foam expansion agent composition of this disclosure and an active hydrogen-containing compound having two or more active hydrogens.

This disclosure also provides a closed-cell polyurethane or polyisocyanurate polymer foam prepared from reaction of an effective amount of the foam-forming composition of this disclosure and a suitable polyisocyanate.

This disclosure also provides a process for producing a closed-cell polyurethane or polyisocyanurate polymer foam. The process comprises reacting an effective amount of the foam-forming composition of this disclosure and a suitable polyisocyanate.

### BRIEF SUMMARY OF THE DRAWINGS

FIG. 1 is a graphical representation of the k-factor of foams comprising Z-1,1,1,4,4,4-hexafluoro-2-butene (Z-FC-1336mzz) or cyclopentane (CP) as the only foam expansion agent as a function of temperature.

FIG. 2 is a graphical representation of the k-factor of a foam prepared using foam expansion agent compositions comprising Z-1,1,1,4,4,4-hexafluoro-2-butene and cyclopentane in accordance with several embodiments of the present disclosure, as a function of temperature.

FIG. 3 is a graphical representation of the percentage change in k-factor compared to the lowest k-factor of foams produced using either Z-1,1,1,4,4,4-hexafluoro-2-butene or cyclopentane alone as the foam expansion agent at a given temperature.

### DETAILED DESCRIPTION

The foregoing general description and the following detailed description are exemplary and explanatory only and are not restrictive of the invention, as defined in the appended claims. Other features and benefits of any one or more of the embodiments will be apparent from the following detailed description, and from the claims.

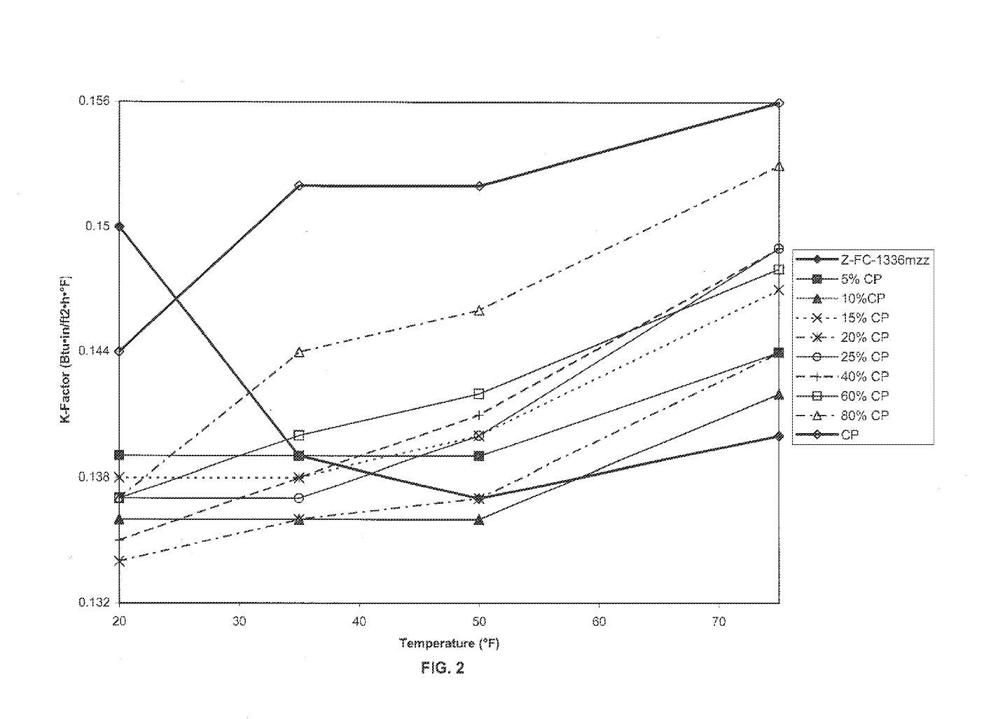

As used herein, the phrase “effective amount of at least one high boiling foam expansion agent to lower the k-factor of a foam using Z-1,1,1,4,4,4-hexafluoro-2-butene alone and a foam using the at least one high boiling point foam expansion agent alone,” effective amount of at least one high boiling point foam expansion agent to lower the k-factor of a foam made using either Z-1,1,1,4,4,4-hexafluoro-2-butene or the at least one high boiling point foam expansion agent alone,” and variations thereof means that the foam expansion agent composition comprises an amount of the at least one high boiling point foam expansion agent sufficient to prepare a foam using the foam expansion agent composition having a lower k-factor than a foam formed using the Z-1,1,1,4,4,4-hexafluoro-2-butene alone and a foam using the at least one high boiling point foam expansion agent alone at the same temperature, for example, at a temperature of 20° F. For example, as shown in FIG. 2, 5 wt. % of cyclopentane may be an effective amount of the at least one high boiling point foam expansion agent having a high boiling point at temperatures up to 35° F. Similarly, below temperatures of 35° F., an effective amount of cyclopentane as the at least one high boiling point foam expansion agent may include amounts such as 5 wt. %, 10 wt. %, 15 wt. %, 20 wt. %, or 25 wt. %. Thus, for the example shown in FIG. 2, the “effective amount of at least one high boiling point foam expansion agent to lower the k-factor of a foam using Z-1,1,1,4,4,4-hexafluoro-2-butene alone and a foam using the at least one high boiling point foam expansion agent when used alone” comprises any amount of the at least one high boiling point foam expansion agent that results in a foam having a k-factor that lies below the curves for both of the individual foam expansion agents used alone.

As used herein, the phrase “k-factor at a temperature” and variations thereof refers to the k-factor as measured at a mean temperature using standard practices. For example, a k-factor of a foam at 20° F. means the k-factor of a foam measured at a mean temperature of 20° F., e.g., the average temperature between two temperature controlled plates maintained at −3° F. and 43° F., respectively, in an apparatus that measures heat transfer.

As used herein, the phrase “effective amount of the foam-forming composition” and variations thereof means an amount of the foam-forming composition, which, when reacted with a suitable polyisocyanate, results in a closed-cell polyurethane or polyisocyanurate polymer foam. As used herein, the phrase “a suitable polyisocyanate” and variations thereof means a polyisocyanate which can react with foam-forming compositions of this disclosure to form closed-cell polyurethane or polyisocyanurate polymer foams.

As used herein, the phrase “total weight of the foam expansion agents” and variations therein means the total weight of Z-1,1,1,4,4,4-hexafluoro-2-butene and the at least one high boiling point foam expansion agent present in the foam expansion agent composition. Similarly, the phrase “all of the foam expansion agents” refers to the Z-1,1,1,4,4,4-hexafluoro-2-butene and the at least one high boiling point foam expansion agent present in the foam expansion agent composition.

As used herein, the phrase “high boiling point foam expansion agent” refers to a foam expansion agent that has a normal boiling point greater than about 15° C. In some embodiments of the present disclosure, a high boiling point foaming agent may have a boiling point greater than 17° C., 20° C., 25° C., 35° C., 45° C., or 50° C. In other embodiments, a high boiling point foaming agent may have a boiling point even higher.

As used herein, the phrase “normal boiling point” means the boiling temperature of a liquid at which vapor pressure is equal to one atmosphere.

As indicated above, this disclosure provides a foam expansion agent composition comprising (a) Z-1,1,1,4,4,4-hexafluoro-2-butene and (b) an effective amount of at least one high boiling point foam expansion agent to lower the k-factor of a foam produced using Z-1,1,1,4,4,4-hexafluoro-2-butene alone and a form produced using the at least one high boiling point foam expansion agent when used alone at the same temperature. In at least one embodiment, the foam is a polyurethane foam or a polyisocyanurate foam.

1,1,1,4,4,4-Hexafluoro-2-butene, CF₃CH═CHCF₃, is a known compound, and its preparation method has been disclosed, for example, in U.S. Patent Publication No. 2009-0012335-A1, hereby incorporated by reference in its entirety. The Z-isomer of 1,1,1,4,4,4-hexafluoro-2-butene has been disclosed, for example, in U.S. Patent Publication No. 2008-0269532-A1, hereby incorporated by reference in its entirety. U.S. patent application Ser. No. 13/081,570, hereby incorporated by reference in its entirety, discloses a foaming composition comprising Z-1,1,1,4,4,4-hexafluoro-2-butene and water.

The foam expansion agent composition of this disclosure can be prepared in any manner convenient to one skilled in this art, including simply weighing desired quantities of each component and, thereafter, combining them in an appropriate container at appropriate temperatures and pressures or mixing them in situ during foam manufacture.

In at least one embodiment of this disclosure, the at least one high boiling point foam expansion agent may be chosen from methyl formate, pentane, isopentane, HFC-365mfc, trans-1,2-dichloroethylene, HFC-245fa, dimethoxymethane, cyclopentane, and combinations thereof. Although the following examples and embodiments are described using cyclopentane as the at least one high boiling point foam expansion agent, the other disclosed foam expansion agents and combinations thereof may be used. One of ordinary skill in the art would recognize and understand how to determine appropriate amounts of the at least one high boiling point foam expansion agent by the teachings and examples of the present disclosure based on the k-factors of foams using the individual components of the foam expansion agent composition, and the k-factor of foams using the foam expansion agent composition.

It has surprisingly been discovered that the high boiling point foam expansion agents disclosed herein are capable of producing a foam having a k-factor less than foams made using either Z-1,1,1,4,4,4-hexafluoro-2-butene or the at least one high boiling point foam expansion agent alone at relatively low temperatures, e.g., at temperatures of approximately less than 50° F. (10° C.). FIG. 2 shows a graphical representation of the k-factor of foams made using Z-1,1,1,4,4,4-hexafluoro-2-butene alone, cyclopentane alone, and compositions comprising Z-1,1,1,4,4,4-hexafluoro-2-butene and cyclopentane.

According to at least one embodiment, the at least one high boiling point foam expansion agent comprises cyclopentane. In at least one embodiment, the foam expansion agent composition comprises cyclopentane in an amount ranging from about 1 wt. % to about 99 wt. % of cyclopentane with respect to the total weight of Z-1,1,1,4,4,4-hexafluoro-2-butene and the at least one high boiling point foam expansion agent. According to at least one further embodiment, the foam expansion agent composition comprises cyclopentane in an amount ranging from about 1 wt. % to about 80 wt. % of cyclopentane, such as from about 1 wt. % to about 60 wt. % of cyclopentane, about 1 wt. % to about 40 wt. % of cyclopentane, about 5 wt. % to about 40 wt. % of cyclopentane, or about 5 wt. % to about 20 wt. % of cyclopentane, with respect to the total weight of foam expansion agents present in the foam expansion agent composition. In at least one embodiment, the foam expansion agent composition comprises about 10 wt. % cyclopentane with respect to the total weight of Z-1,1,1,4,4,4-hexafluoro-2-butene and the at least one high boiling point foam expansion agent.

In other embodiments, the foam expansion agent composition may comprise cyclopentane in an amount ranging from about 10 wt. % to about 90 wt. % relative to the total weight of the foam expansion agents in the foam expansion agent composition. In further embodiments, the foam expansion agent composition may comprise cyclopentane in an amount ranging from about 20 wt. % to about 80 wt. % relative to the total weight of the foam expansion agents in the foam expansion agent composition. In yet other embodiments, the foam expansion agent composition may comprise cyclopentane in an amount ranging from about 35 wt. % to about 80 wt. % relative to the total weight of foam expansion agents in the foam expansion agent composition.

This disclosure also provides a foam-forming composition comprising (a) the foam expansion agent composition which comprises Z-1,1,1,4,4,4-hexafluoro-2-butene and at least one high boiling point foam expansion agent as described in this disclosure, and (b) an active hydrogen-containing compound having two or more active hydrogens. The foam expansion agent composition of the foam-forming composition may comprise the foam expansion agent composition described in any of the above embodiments.

In some embodiments of this invention, the foam-forming composition comprises (a) the foam expansion agent composition which comprises Z-1,1,1,4,4,4-hexafluoro-2-butene and at least one high boiling point foam expansion agent as described in this disclosure, and (b) an active hydrogen-containing compound having two or more active hydrogens. In some embodiments of this invention, these active hydrogens are in the form of hydroxyl groups.

The active hydrogen-containing compounds of this disclosure can comprise compounds having two or more groups that contain an active hydrogen atom reactive with an isocyanate group, such as described in U.S. Pat. No. 4,394,491, hereby incorporated by reference. Examples of such compounds have at least two hydroxyl groups per molecule, and more specifically comprise polyols, such as polyether or polyester polyols. Examples of such polyols are those which have an equivalent weight of about 50 to about 700, normally of about 70 to about 300, more typically of about 90 to about 270, and carry at least 2 hydroxyl groups, usually 3 to 8 such groups.

Examples of suitable polyols comprise polyester polyols such as aromatic polyester polyols, e.g., those made by transesterifying polyethylene terephthalate (PET) scrap with a glycol such as diethylene glycol, or made by reacting phthalic anhydride with a glycol. The resulting polyester polyols may be reacted further with ethylene and/or propylene oxide to form an extended polyester polyol containing additional internal alkyleneoxy groups. A non-limiting example of a suitable polyester polyol is STEPANPOL® PS-2502 from Stepan Co.

Examples of suitable polyols also comprise polyether polyols such as polyethylene oxides, polypropylene oxides, mixed polyethylene-propylene oxides with terminal hydroxyl groups, among others. Other suitable polyols can be prepared by reacting ethylene and/or propylene oxide with an initiator having 2 to 16, generally 3 to 8 hydroxyl groups as present, for example, in glycerol, pentaerythritol and carbohydrates such as sorbitol, glucose, sucrose and the like polyhydroxy compounds. Suitable polyether polyols can also include aliphatic or aromatic amine-based polyols. Non-limiting examples of polyether polyols include VORANOL® 490, a sucrose/glycerine initiated polyether polyol from Dow Chemical Co., and VORANOL® 391, an amine initiated aromatic polyether from Dow Chemical Co.

The foam-forming composition of this disclosure can be prepared in any manner convenient to one skilled in this art, including simply weighing desired quantities of each component and, thereafter, combining them in an appropriate container at appropriate temperatures and pressures.

This disclosure also provides processes for producing a closed-cell polyurethane or polyisocyanurate polymer foam which comprises reacting an effective amount of the foam-forming compositions of this disclosure with a suitable polyisocyanate.

Typically, before reacting with a suitable polyisocyanate, the active hydrogen-containing compound and optionally other additives are mixed with the foam expansion agent composition to form a foam-forming composition. Such foam-forming composition is typically known in the art as an isocyanate-reactive preblend, or B-side composition.

When preparing polyurethane or polyisocyanurate polymer foams, the polyisocyanate reactant is normally selected in such proportion relative to that of the active hydrogen-containing compound that the ratio of the equivalents of isocyanate groups to the equivalents of active hydrogen groups, i.e., the foam index, is from about 0.9 to about 10 and in most cases from about 1 to about 4.

While any suitable polyisocyanate can be employed in the instant process, examples of suitable polyisocyanates useful for making polyurethane or polyisocyanurate foam comprise at least one of aromatic, aliphatic and cycloaliphatic polyisocyanates, among others. Representative members of these compounds comprise diisocyanates such as meta- or paraphenylene diisocyanate, toluene-2,4-diisocyanate, toluene-2,6-diisocyanate, hexamethylene-1,6-diisocyanate, tetramethylene-1,4-diisocyanate, cyclohexane-1,4-diisocyanate, hexahydrotoluene diisocyanate (and isomers), napthylene-1,5-diisocyanate, 1-methylphenyl-2,4-phenyldiisocyanate, diphenylmethane-4,4-diisocyanate, diphenylmethane-2,4-diissocyanate, 4,4-biphenylenediisocyanate and 3,3-dimethyoxy-4,4 biphenylenediisocyanate and 3,3-dimethyldiphenylpropane-4,4-diisocyanate; triisocyanates such as toluene-2,4,6-triisocyanate and polyisocyanates such as 4,4-dimethyldiphenylmethane-2,2,5,5-tetraisocyanate and the diverse polymethylenepoly-phenylopolyisocyanates, mixtures thereof, among others. For example, PAPI 27, a polymethylene polyphenyl isocyanate from Dow Chemical Co., may be used in accordance with the present disclosure.

A crude polyisocyanate may also be used in the practice of this invention, such as the crude toluene diisocyanate obtained by the phosgenating a mixture comprising toluene diamines, or the crude diphenylmethane diisocyanate obtained by the phosgenating crude diphenylmethanediamine. Specific examples of such compounds comprise methylene-bridged polyphenylpolyisocyanates, due to their ability to crosslink the polyurethane.

It is often desirable to employ minor amounts of additives in preparing polyurethane or polyisocyanurate polymer foams. Among these additives comprise one or more members selected from the group consisting of catalysts, surfactants, flame retardants, preservatives, colorants, antioxidants, reinforcing agents, filler, antistatic agents, among others well known in this art.

Depending upon the composition, a surfactant can be employed to stabilize the foaming reaction mixture while curing. Such surfactants normally comprise a liquid or solid organosilicone compound. The surfactants may be employed in amounts sufficient to stabilize the foaming reaction mixture against collapse and to prevent the formation of large, uneven cells. In one embodiment of this invention, about 0.1% to about 5% by weight of surfactant based on the total weight of all foaming ingredients (i.e. foam expansion agent composition+active hydrogen-containing compounds+polyisocyanates+additives) are used. In another embodiment of this invention, about 1.5% to about 3% by weight of surfactant based on the total weight of all foaming ingredients are used. An example of one surfactant that may be used in accordance with the present disclosure comprises NIAX Silicone L-6900, a surfactant comprising 60-90% siloxane polyalkyleneoxide copolymer and 10-30% polyalkylene oxide available from Momentive Performance Materials.

One or more catalysts for the reaction of the active hydrogen-containing compounds, e.g. polyols, with the polyisocyanate may be also employed. While any suitable urethane catalyst may be employed, specific catalysts may comprise tertiary amine compounds and organometallic compounds. Exemplary catalysts are disclosed, for example, in U.S. Pat. No. 5,164,419, which disclosure is incorporated herein by reference. For example, a catalyst for the trimerization of polyisocyanates, such as an alkali metal alkoxide, alkali metal carboxylate, or quaternary amine compound, may also optionally be employed herein. Such catalysts are used in an amount which measurably increases the rate of reaction of the polyisocyanate. Typical amounts of catalysts are about 0.1% to about 5% by weight based on the total weight of all foaming ingredients. Non-limiting examples of catalysts include POLYCAT® 8, N,N-dimethylcyclohexylamine from Air Products Inc., POLYCAT® 5, pentamethyldiethylenetriamine from Air Products Inc., and CURITHANE® 52, 2-methyl(n-methyl amino b-sodium acetate nonyl phenol) from Air Products Inc.

In the process of the invention for making a polyurethane or polyisocyanurate polymer foam, the active hydrogen-containing compound (e.g. polyol), polyisocyanate, foam expansion agent composition and other components are contacted, thoroughly mixed, and permitted to expand and cure into a cellular polymer. The mixing apparatus is not critical, and various conventional types of mixing head and spray apparatus may be used. By conventional apparatus is meant apparatus, equipment, and procedures conventionally employed in the preparation of polyurethane and polyisocyanurate polymer foams in which conventional foam expansion agents, such as fluorotrichloromethane (CCl₃F, CFC-11), are employed. Such conventional apparatus are discussed by: H. Boden et al. in chapter 4 of the Polyurethane Handbook, edited by G. Oertel, Hanser Publishers, New York, 1985; a paper by H. Grunbauer et al. titled “Fine Celled CFC-Free Rigid Foam—New Machinery with Low Boiling Blowing Agents” published in Polyurethanes 92 from the Proceedings of the SPI 34th Annual Technical/Marketing Conference, Oct. 21-Oct. 24, 1992, New Orleans, La.; and a paper by M. Taverna et al. titled “Soluble or Insoluble Alternative Blowing Agents?Processing Technologies for Both Alternatives, Presented by the Equipment Manufacturer”, published in Polyurethanes World Congress 1991 from the Proceedings of the SPI/ISOPA Sep. 24-26, 1991, Acropolis, Nice, France. These disclosures are hereby incorporated by reference.

In some embodiments of this invention, a preblend of certain raw materials is prepared prior to reacting the polyisocyanate and active hydrogen-containing components. For example, it is often useful to blend the polyol(s), foam expansion agent composition, surfactant(s), catalysts(s) and other foaming ingredients, except for polyisocyanates, and then contact this blend with the polyisocyanate. Alternatively, all the foaming ingredients may be introduced individually to the mixing zone where the polyisocyanate and polyol(s) are contacted. It is also possible to pre-react all or a portion of the polyol(s) with the polyisocyanate to form a prepolymer.

The compositions and processes of this invention are applicable to the production of all kinds of expanded closed cell polyurethane and polyisocyanurate polymer foams, including, for example, spray insulation, pour-in-place appliance foams, or as rigid insulating board stock and laminates.

This disclosure also provides a closed-cell polyurethane or polyisocyanurate polymer foam prepared from reaction of an effective amount of the foam-forming composition of this disclosure with a suitable polyisocyanate.

In some embodiments of this invention, such closed-cell polyurethane or polyisocyanurate polymer foams prepared hereinabove have a k-factor less than a foam using only Z-1,1,1,4,4,4-hexafluoro-2-butene or the at least one high boiling point foam expansion agent as described above, such as at least 0.005 Btu·in/ft²·h·° F. lower. In at least one embodiment, the closed-cell polyurethane or polyisocyanurate polymer foam prepared hereinabove has a k-factor at least 0.01 Btu·in/ft²·h·° F. less than a foam using only Z-1,1,1,4,4,4-hexafluoro-2-butene or the at least one high boiling point foam expansion agent as described above. In at least one further embodiment, the closed-cell polyurethane or polyisocyanurate polymer foam prepared hereinabove has a k-factor at least 0.015 Btu·in/ft²·h·° F. less than a foam using only Z-1,1,1,4,4,4-hexafluoro-2-butene or the at least one high boiling point foam expansion agent as described above.

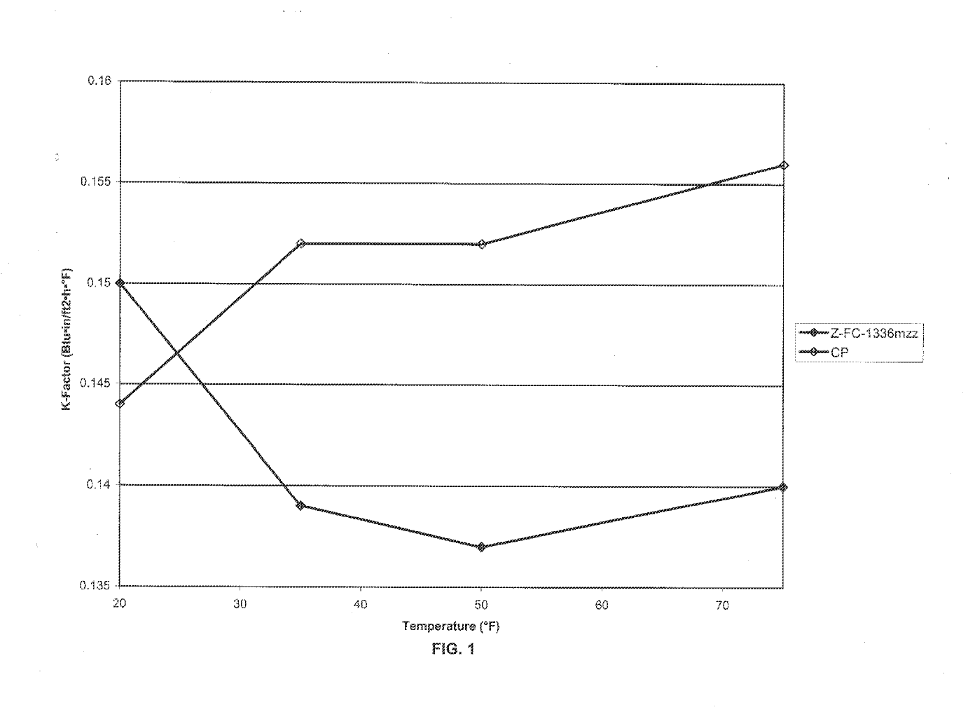

FIG. 1 graphically depicts the k-factor of foams produced using only Z-1,1,1,4,4,4-hexafluoro-2-butene and only cyclopentane as the foam expansion agent in their respective foams. As seen in FIG. 1, the k-factor of a foam produced using only Z-1,1,1,4,4,4-hexafluoro-2-butene exhibits a local minimum and increases as the temperature gets higher or lower than the temperature at the local minimum. It is also noted that a foam produced using only cyclopentane as the foam expansion agent has a lower k-factor than a foam produced using only Z-1,1,1,4,4,4-hexafluoro-2-butene as the foam expansion agent at temperatures less than about 23° F. The foam expansion agent compositions in accordance with the present invention are those capable of producing a foam having a k-factor less than the k-factor of foams using only Z-1,1,1,4,4,4-hexafluoro-2-butene or the at least one high boiling point foam expansion agent that comprise the foam expansion agent composition at a given temperature. When the at least one high boiling point foam expansion agent consists essentially of cyclopentane, the foam expansion agent composition of the present disclosure is chosen such that the k-factor of the produced foam is less than the k-factor of a foam produced using Z-1,1,1,4,4,4-hexafluoro-2-butene alone at temperatures greater than about 23° F. and less than the k-factor of a foam producing using cyclopentane alone at temperatures less than about 23° F. One of ordinary skill in the art would recognize that the at least one high boiling point foam expansion agent used in the foam expansion agent composition of the present disclosure may be selected such that the foam produced has a k-factor lower than foam using Z-1,1,1,4,4,4-hexafluoro-2-butene alone and lower than foam using the at least one high boiling point foam expansion agent at a given temperature.

FIG. 2 graphically represents the k-factor of foams produced in accordance with the present disclosure as a function of temperature. The foam expansion agent compositions used to produce the foams comprised various compositions of Z-1,1,1,4,4,4-hexafluoro-2-butene and cyclopentane.

In at least one embodiment of the present disclosure, a foam prepared with the foam expansion agent composition of the present invention has a k-factor at least 1% less than a foam prepared using only Z-1,1,1,4,4,4-hexafluoro-2-butene or the at least one high boiling point foam expansion agent at a specified temperature, such as 50° F. or less, 35° or less, or 20° F. or less. In accordance with at least one further embodiment of the present disclosure, a foam prepared with the foam expansion agent composition of the present invention has a k-factor at least 2% less than a foam prepared using only Z-1,1,1,4,4,4-hexafluoro-2-butene or the at least one high boiling point foam expansion agent as described above. In further embodiments, a foam prepared with the foam expansion agent composition of the present invention has a k-factor at least 4%, at least 5%, at least 6%, or at least 8% less than a foam prepared using only Z-1,1,1,4,4,4-hexafluoro-2-butene or the at least one high boiling point foam expansion agent as described above.

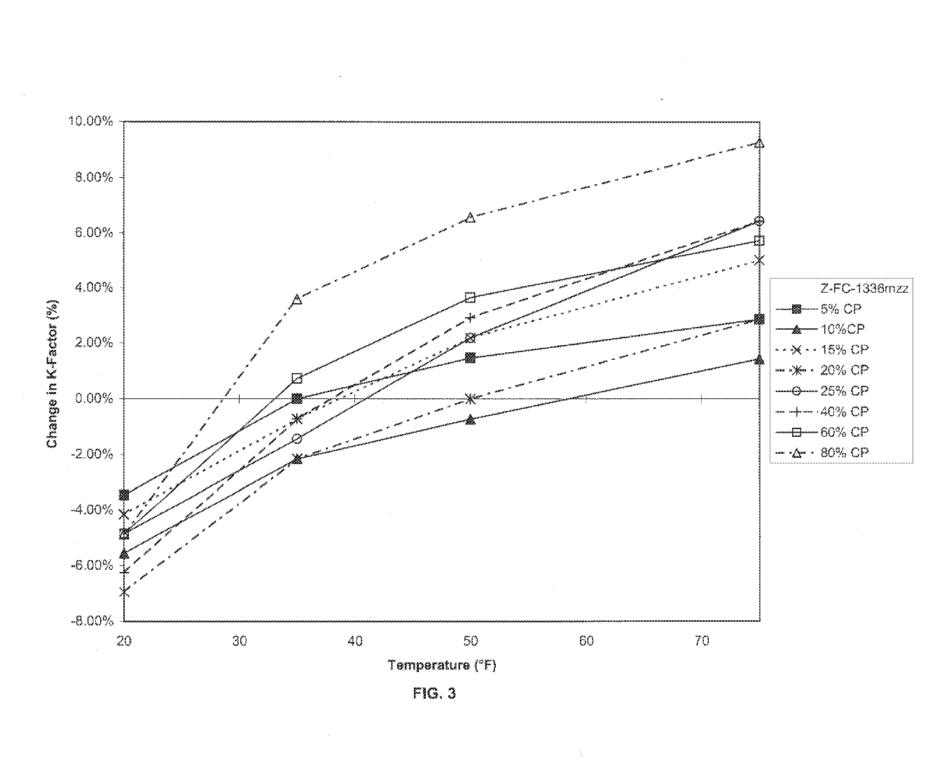

FIG. 3 graphically represents the percentage change in k-factor of foams produced in accordance with the present disclosure compared to the lowest k-factor of foams produced using either Z-1,1,1,4,4,4-hexafluoro-2-butene or cyclopentane alone. For example, at low temperatures, foams produced using cyclopentane alone have lower k-factors than foams produced using Z-1,1,1,4,4,4-hexafluoro-2-butene alone. The foam expansion agent compositions according to the present disclosure comprising cyclopentane as the at least one high boiling point foam expansion agent are those which show a decrease (i.e., a negative change in the k-factor) compared to foams produced using only Z-1,1,1,4,4,4-hexafluoro-2-butene or cyclopentane.

The closed-cell polyurethane or polyisocyanurate polymer foams used in the refrigerators, freezers, refrigerated trailers, walk-in cold-storage, et al. are subject to low temperatures. In these applications, a foam expansion agent may condense in the cell and lose its insulation effectiveness. It was surprisingly found through experiments that the presence of at least one high boiling point foam expansion agent, such as, for example, cyclopentane, in a foam expansion agent composition comprising Z-1,1,1,4,4,4-hexafluoro-2-butene may lower the k-factor of the resulting closed-cell polyurethane or polyisocyanurate polymer foam below that of the foam made by Z-1,1,1,4,4,4-hexafluoro-2-butene or the at least one high boiling point foam expansion agent alone under the same conditions. For example, cyclopentane, which has a normal boiling point of 120° F., has a higher k-factor in a foam produced using cyclopentane than in a foam produced using Z-1,1,1,4,4,4-hexafluoro-2-butene at temperatures greater than about 23° F. Surprisingly, a foam made using a foam expansion agent composition comprised of Z-1,1,1,4,4,4-hexafluoro-2-butene and about 5 wt. % to about 40 wt. % of cyclopentane, relative to the total weight of foam expansion agents, has a k-factor lower than that of a foam made by Z-1,1,1,4,4,4-hexafluoro-2-butene or cyclopentane alone under the same conditions at temperatures less than about 35° C. The decreased k-factor is unexpected because one of ordinary skill in the art would predict that the k-factor of a foam produced by a composition containing both Z-1,1,1,4,4,4-hexafluoro-2-butene and cyclopentane would have a k-factor with a value lying between the k-factors of foams made using foam made by Z-1,1,1,4,4,4-hexafluoro-2-butene alone and cyclopentane alone under the same conditions. Furthermore, one of ordinary skill in the art would expect low temperature performance to further decline because the cyclopentane would be expected to have condensed at temperatures less than about 50° F. (10° C.), a temperature well below the normal boiling point of cyclopentane.

Many aspects and embodiments have been described above and are merely exemplary and not limiting. After reading this specification, skilled artisans appreciate that other aspects and embodiments are possible without departing from the scope of the invention.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

The use of the terms “about” and “approximately” are used herein to denote a degree of uncertainty in the values they describe. One of ordinary skill in the art would recognize that the degree of uncertainty is a result of normal experimental variability, such as the reproducibility of experimental results, accuracy of measuring equipment, and the various other factors that result in small deviations from the stated values.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

### EXAMPLES

The concepts described herein will be further described in the following examples, which do not limit the scope of the invention described in the claims.

### Example 1 (Comparative)

In Comparative Example 1, a polyisocyanurate foam using a foam expansion agent composition comprising only Z-1,1,1,4,4,4-hexafluoro-2-butene. The foam-forming composition is shown in Table 1.1. The foam-forming composition comprised 0.256 moles of the foam expansion agent composition and 0.094 moles of water. The k-factor of the resultant foam at various temperatures is shown in Table 1.2. The k-factor was measured approximately one day after the production of the foam. The foam exhibited good dimensional stability and cell structure, and had a density of 1.7 pcf.

TABLE 1.1

| Component | Quantity (pbw) |
|---|---|
| VORANOL ® 490 | 40 |
| VORANOL ® 391 | 35 |
| STEPANPOL ® PS2502A | 25 |
| NIAX Silicone L-6900 | 6.0 |
| POLYCAT ® 8 | 3.0 |
| POLYCAT ® 5 | 0.375 |
| CURITHANE ® 52 | 0.5 |
| Water | 1.7 |
| Foam Expansion Agent Composition | 42.1 |
| Z-1,1,1,4,4,4-hexafluoro-2-butene | 42.1 |
| Cyclopentane | 0 |
| PAPI 27 | 148 |

TABLE 1.2

| Mean Temperature | K-Factor (Btu · in/ft² · h · ° F.) |
|---|---|
| Mean Temperature = 75° F. | 0.140 |
| (50° F./100° F.) | |
| Mean Temperature = 50° F. | 0.137 |
| (25° F./75° F.) | |
| Mean Temperature = 35° F. | 0.139 |
| (10° F./60° F.) | |
| Mean Temperature = 20° F. | 0.150 |
| (−3° F./43° F.) | |

### Example 2 (Comparative)

In Comparative Example 2, a polyisocyanurate foam using a foam expansion agent composition comprising only cyclopentane under the same conditions as described above for Comparative Example 1. The foam-forming composition is shown in Table 2.1. The foam-forming composition comprised 0.256 moles of the foam expansion agent composition and 0.094 moles of water. The k-factor of the resultant foam at various temperatures is shown in Table 2.2. The k-factor was measured approximately one day after the production of the foam. The foam exhibited good dimensional stability and cell structure, and had a density of 1.7 pcf.

TABLE 2.1

| Component | Quantity (pbw) |
|---|---|
| VORANOL ® 490 | 40 |
| VORANOL ® 391 | 35 |
| STEPANPOL ® PS2502A | 25 |
| NIAX Silicone L-6900 | 6.0 |
| POLYCAT ® 8 | 3.0 |
| POLYCAT ® 5 | 0.375 |
| CURITHANE ® 52 | 0.5 |
| Water | 1.7 |
| Foam Expansion Agent Composition | 18.0 |
| Z-1,1,1,4,4,4-hexafluoro-2-butene | 0 |
| Cyclopentane | 18.0 |
| PAPI 27 | 148 |

TABLE 2.2

| Mean Temperature | K-Factor (Btu · in/ft² · h · ° F.) |
|---|---|
| Mean Temperature = 75° F. | 0.156 |
| (50° F./100° F.) | |
| Mean Temperature = 50° F. | 0.152 |
| (25° F./75° F.) | |
| Mean Temperature = 35° F. | 0.152 |
| (10° F./60° F.) | |
| Mean Temperature = 20° F. | 0.144 |
| (−3° F./43° F.) | |

### Example 3

In Example 3, a polyisocyanurate foam using a foam expansion agent composition comprising Z-1,1,1,4,4,4-hexafluoro-2-butene and 5 wt. % cyclopentane, relative to the total weight of the foam expansion agents, under the same conditions as described above for Comparative Example 1. The foam-forming composition is shown in Table 3.1. The k-factor of the resultant foam at various temperatures is shown in Table 3.2. The foam-forming composition comprised 0.256 moles of the foam expansion agent composition and 0.094 moles of water. The k-factor was measured approximately one day after the production of the foam. The foam exhibited good dimensional stability and cell structure, and had a density of 1.7 pcf.

TABLE 3.1

| Component | Quantity (pbw) |
|---|---|
| VORANOL ® 490 | 40 |
| VORANOL ® 391 | 35 |
| STEPANPOL ® PS2502A | 25 |
| NIAX Silicone L-6900 | 6.0 |
| POLYCAT ® 8 | 3.0 |
| POLYCAT ® 5 | 0.375 |
| CURITHANE ® 52 | 0.5 |
| Water | 1.7 |
| Foam Expansion Agent Composition | 39.4 |
| Z-1,1,1,4,4,4-hexafluoro-2-butene | 37.4 |
| Cyclopentane | 2.0 |
| PAPI 27 | 148 |

TABLE 3.2

| Mean Temperature | K-Factor (Btu · in/ft² · h · ° F.) |
|---|---|
| Mean Temperature = 75° F. | 0.144 |
| (50° F./100° F.) | |
| Mean Temperature = 50° F. | 0.139 |
| (25° F./75° F.) | |
| Mean Temperature = 35° F. | 0.139 |
| (10° F./60° F.) | |
| Mean Temperature = 20° F. | 0.139 |
| (−3° F./43° F.) | |

### Example 4

In Example 4, a polyisocyanurate foam using a foam expansion agent composition comprising Z-1,1,1,4,4,4-hexafluoro-2-butene and 10 wt. % cyclopentane, relative to the total weight of the foam expansion agents, under the same conditions as described above for Comparative Example 1. The foam-forming composition is shown in Table 4.1. The k-factor of the resultant foam at various temperatures is shown in Table 4.2. The foam-forming composition comprised 0.256 moles of the foam expansion agent composition and 0.094 moles of water. The k-factor was measured approximately one day after the production of the foam. The foam exhibited good dimensional stability and cell structure, and had a density of 1.7 pcf.

TABLE 4.1

| Component | Quantity (pbw) |
|---|---|
| VORANOL ® 490 | 40 |
| VORANOL ® 391 | 35 |
| STEPANPOL ® PS2502A | 25 |
| NIAX Silicone L-6900 | 6.0 |
| POLYCAT ® 8 | 3.0 |
| POLYCAT ® 5 | 0.375 |
| CURITHANE ® 52 | 0.5 |
| Water | 1.7 |
| Foam Expansion Agent Composition | 37.1 |
| Z-1,1,1,4,4,4-hexafluoro-2-butene | 33.4 |
| Cyclopentane | 3.7 |
| PAPI 27 | 148 |

TABLE 4.2

| Mean Temperature | K-Factor (Btu · in/ft² · h · ° F.) |
|---|---|
| Mean Temperature = 75° F. | 0.142 |
| (50° F./100° F.) | |
| Mean Temperature = 50° F. | 0.136 |
| (25° F./75° F.) | |
| Mean Temperature = 35° F. | 0.136 |
| (10° F./60° F.) | |
| Mean Temperature = 20° F. | 0.136 |
| (−3° F./43° F.) | |

### Example 5

In Example 5, a polyisocyanurate foam using a foam expansion agent composition comprising Z-1,1,1,4,4,4-hexafluoro-2-butene and 15 wt. % cyclopentane, relative to the total weight of the foam expansion agents, under the same conditions as described above for Comparative Example 1. The foam-forming composition is shown in Table 5.1. The k-factor of the resultant foam at various temperatures is shown in Table 5.2. The foam-forming composition comprised 0.256 moles of the foam expansion agent composition and 0.094 moles of water. The k-factor was measured approximately one day after the production of the foam. The foam exhibited good dimensional stability and cell structure, and had a density of 1.7 pcf.

TABLE 5.1

| Component | Quantity (pbw) |
|---|---|
| VORANOL ® 490 | 40 |
| VORANOL ® 391 | 35 |
| STEPANPOL ® PS2502A | 25 |
| NIAX Silicone L-6900 | 6.0 |
| POLYCAT ® 8 | 3.0 |
| POLYCAT ® 5 | 0.375 |
| CURITHANE ® 52 | 0.5 |
| Water | 1.7 |
| Foam Expansion Agent Composition | 35.0 |
| Z-1,1,1,4,4,4-hexafluoro-2-butene | 29.8 |
| Cyclopentane | 5.2 |
| A: PAPI 27 | 148 |

TABLE 5.2

| Mean Temperature | K-Factor (Btu · in/ft² · h · ° F.) |
|---|---|
| Mean Temperature = 75° F. | 0.147 |
| (50° F./100° F.) | |
| Mean Temperature = 50° F. | 0.140 |
| (25° F./75° F.) | |
| Mean Temperature = 35° F. | 0.138 |
| (10° F./60° F.) | |
| Mean Temperature = 20° F. | 0.138 |
| (−3° F./43° F.) | |

### Example 6

In Example 6, a polyisocyanurate foam using a foam expansion agent composition comprising Z-1,1,1,4,4,4-hexafluoro-2-butene and 20 wt. % cyclopentane, relative to the total weight of the foam expansion agents, under the same conditions as described above for Comparative Example 1. The foam-forming composition is shown in Table 6.1. The k-factor of the resultant foam at various temperatures is shown in Table 6.2. The foam-forming composition comprised 0.256 moles of the foam expansion agent composition and 0.094 moles of water. Except where noted, the k-factor was measured approximately one day after the production of the foam. The foam exhibited good dimensional stability and cell structure, and had a density of 1.7 pcf.

TABLE 6.1

| Component | Quantity (pbw) |
|---|---|
| VORANOL ® 490 | 40 |
| VORANOL ® 391 | 35 |
| STEPANPOL ® PS2502A | 25 |
| NIAX Silicone L-6900 | 6.0 |
| POLYCAT ® 8 | 3.0 |
| POLYCAT ® 5 | 0.375 |
| CURITHANE ® 52 | 0.5 |
| Water | 1.7 |
| Foam Expansion Agent Composition | 33.2 |
| Z-1,1,1,4,4,4-hexafluoro-2-butene | 26.6 |
| Cyclopentane | 6.6 |
| PAPI 27 | 148 |

TABLE 6.2

| Mean Temperature | K-Factor (Btu · in/ft² · h · ° F.) |
|---|---|
| Mean Temperature = 75° F. | 0.144 |
| (50° F./100° F.) | |
| Mean Temperature = 50° F. | 0.137 |
| (25° F./75° F.) | |
| Mean Temperature = 35° F. | 0.136 |
| (10° F./60° F.) | |
| Mean Temperature = 20° F. | 0.134 |
| (−3° F./43° F.) | |

### Example 7

In Example 7, a polyisocyanurate foam using a foam expansion agent composition comprising Z-1,1,1,4,4,4-hexafluoro-2-butene and 25 wt. % cyclopentane, relative to the total weight of the foam expansion agents, under the same conditions as described above for Comparative Example 1. The foam-forming composition is shown in Table 7.1. The k-factor of the resultant foam at various temperatures is shown in Table 7.2. The foam-forming composition comprised 0.256 moles of the foam expansion agent composition and 0.094 moles of water. The k-factor was measured approximately one day after the production of the foam. The foam exhibited good dimensional stability and cell structure, and had a density of 1.7 pcf.

TABLE 7.1

| Component | Quantity (pbw) |
|---|---|
| VORANOL ® 490 | 40 |
| VORANOL ® 391 | 35 |
| STEPANPOL ® PS2502A | 25 |
| NIAX Silicone L-6900 | 6.0 |
| POLYCAT ® 8 | 3.0 |
| POLYCAT ® 5 | 0.375 |
| CURITHANE ® 52 | 0.5 |
| Water | 1.7 |
| Foam Expansion Agent Composition | 31.5 |
| Z-1,1,1,4,4,4-hexafluoro-2-butene | 23.6 |
| Cyclopentane | 7.9 |
| PAPI 27 | 148 |

TABLE 7.2

| Mean Temperature | K-Factor (Btu · in/ft² · h · ° F.) |
|---|---|
| Mean Temperature = 75° F. | 0.149 |
| (50° F./100° F.) | |
| Mean Temperature = 50° F. | 0.140 |
| (25° F./75° F.) | |
| Mean Temperature = 35° F. | 0.137 |
| (10° F./60° F.) | |
| Mean Temperature = 20° F. | 0.137 |
| (−3° F./43° F.) | |

### Example 8

In Example 8, a polyisocyanurate foam using a foam expansion agent composition comprising Z-1,1,1,4,4,4-hexafluoro-2-butene and 40 wt. % cyclopentane, relative to the total weight of the foam expansion agents, under the same conditions as described above for Comparative Example 1. The foam-forming composition is shown in Table 8.1. The k-factor of the resultant foam at various temperatures is shown in Table 8.2. The foam-forming composition comprised 0.256 moles of the foam expansion agent composition and 0.094 moles of water. The k-factor was measured approximately one day after the production of the foam. The foam exhibited good dimensional stability and cell structure, and had a density of 1.8 pcf.

TABLE 8.1

| Component | Quantity (pbw) |
|---|---|
| VORANOL ® 490 | 40 |
| VORANOL ® 391 | 35 |
| STEPANPOL ® PS2502A | 25 |
| NIAX Silicone L-6900 | 6.0 |
| POLYCAT ® 8 | 3.0 |
| POLYCAT ® 5 | 0.375 |
| CURITHANE ® 52 | 0.5 |
| Water | 1.7 |
| Foam Expansion Agent Composition | 27.4 |
| Z-1,1,1,4,4,4-hexafluoro-2-butene | 16.4 |
| Cyclopentane | 11.0 |
| PAPI 27 | 148 |

TABLE 8.2

| Mean Temperature | K-Factor (Btu · in/ft² · h · ° F.) |
|---|---|
| Mean Temperature = 75° F. | 0.149 |
| (50° F./100° F.) | |
| Mean Temperature = 50° F. | 0.141 |
| (25° F./75° F.) | |
| Mean Temperature = 35° F. | 0.138 |
| (10° F./60° F.) | |
| Mean Temperature = 20° F. | 0.135 |
| (−3° F./43° F.) | |

### Example 9

In Example 9, a polyisocyanurate foam using a foam expansion agent composition comprising Z-1,1,1,4,4,4-hexafluoro-2-butene and 60 wt. % cyclopentane, relative to the total weight of the foam expansion agents, under the same conditions as described above for Comparative Example 1. The foam-forming composition is shown in Table 9.1. The k-factor of the resultant foam at various temperatures is shown in Table 9.2. The foam-forming composition comprised 0.256 moles of the foam expansion agent composition and 0.094 moles of water. The k-factor was measured approximately one day after the production of the foam. The foam exhibited good dimensional stability and cell structure, and had a density of 1.8 pcf.

TABLE 9.1

| Component | Quantity (pbw) |
|---|---|
| VORANOL ® 490 | 40 |
| VORANOL ® 391 | 35 |
| STEPANPOL ® PS2502A | 25 |
| NIAX Silicone L-6900 | 6.0 |
| POLYCAT ® 8 | 3.0 |
| POLYCAT ® 5 | 0.375 |
| CURITHANE ® 52 | 0.5 |
| Water | 1.7 |
| Foam Expansion Agent Composition | 23.3 |
| Z-1,1,1,4,4,4-hexafluoro-2-butene | 9.3 |
| Cyclopentane | 14.0 |
| PAPI 27 | 148 |

TABLE 9.2

| Mean Temperature | K-Factor (Btu · in/ft² · h · ° F.) |
|---|---|
| Mean Temperature = 75° F. | 0.148 |
| (50° F./100° F.) | |
| Mean Temperature = 50° F. | 0.142 |
| (25° F./75° F.) | |
| Mean Temperature = 35° F. | 0.140 |
| (10° F./60° F.) | |
| Mean Temperature = 20° F. | 0.137 |
| (−3° F./43° F.) | |

### Example 10

In Example 10, a polyisocyanurate foam using a foam expansion agent composition comprising Z-1,1,1,4,4,4-hexafluoro-2-butene and 80 wt. % cyclopentane, relative to the total weight of the foam expansion agents, under the same conditions as described above for Comparative Example 1. The foam-forming composition is shown in Table 10.1. The foam-forming composition comprised 0.256 moles of the foam expansion agent composition and 0.094 moles of water. The k-factor of the resultant foam at various temperatures is shown in Table 10.2. The k-factor was measured approximately one day after the production of the foam. The foam exhibited good dimensional stability and cell structure, and had a density of 1.7 pcf.

TABLE 10.1

| Component | Quantity (pbw) |
|---|---|
| VORANOL ® 490 | 40 |
| VORANOL ® 391 | 35 |
| STEPANPOL ® PS2502A | 25 |
| NIAX Silicone L-6900 | 6.0 |
| POLYCAT ® 8 | 3.0 |
| POLYCAT ® 5 | 0.375 |
| CURITHANE ® 52 | 0.5 |
| Water | 1.7 |
| Foam Expansion Agent Composition | 20.3 |
| Z-1,1,1,4,4,4-hexafluoro-2-butene | 4.1 |
| Cyclopentane | 16.2 |
| PAPI 27 | 148 |

TABLE 10.2

| Mean Temperature | K-Factor (Btu · in/ft² · h · ° F.) |
|---|---|
| Mean Temperature = 75° F. | 0.153 |
| (50° F./100° F.) | |
| Mean Temperature = 50° F. | 0.146 |
| (25° F./75° F.) | |
| Mean Temperature = 35° F. | 0.144 |
| (10° F./60° F.) | |
| Mean Temperature = 20° F. | 0.137 |
| (−3° F./43° F.) | |

What is claimed is:

1. A foam expansion agent composition comprising:
(a) Z-1,1,1,4,4,4-hexafluoro-2-butene; and
(b) an effective amount of at least one high boiling point foam expansion agent,
wherein the effective amount of at least one high boiling point foam expansion agent is sufficient to produce a foam having a lower k-factor than a foam produced using Z-1,1,1,4,4,4-hexafluoro-2-butene alone and a foam produced using the at least one high boiling point foam expansion agent alone,
wherein the at least one high boiling point foam expansion agent has a boiling point great than about 15° C.

2. The foam expansion agent composition of claim 1, wherein said at least one high boiling point foam expansion agent is chosen from methyl formate, pentane, isopentane, HFC-365mfc, trans-1,2-dichloroethylene, HFC-245fa, dimethoxymethane, cyclopentane, and combinations thereof.

3. The foam expansion agent composition of claim 2, wherein said at least one high boiling point foam expansion agent comprises cyclopentane.

4. The foam expansion agent composition of claim 3, wherein the cyclopentane comprises about 5 wt. % to about 80 wt. % of the total weight of the foam expansion agent composition.

5. The foam expansion agent composition of claim 4, wherein the cyclopentane comprises about 5 wt. % to about 60 wt. % of the total weight of the foam expansion agent composition.

6. The foam expansion agent composition of claim 5, wherein the cyclopentane comprises about 5 wt. % to about 40 wt. % of the total weight of the foam expansion agent composition.

7. The foam expansion agent composition of claim 3, wherein the cyclopentane comprises about 10 wt. % of the total weight of the foam expansion agent composition.

8. The composition of claim 1, wherein the at least one high boiling point foam expansion agent is present in an effective amount sufficient to produce a foam having a lower k-factor than a foam produced using Z-1,1,1,4,4,4-hexafluoro-2-butene alone and a foam produced using the at least one high boiling point foam expansion agent alone at a temperature ranging from about 0° F. to about 45° F.

9. The foam expansion agent composition of claim 1, wherein the at least one high boiling point foam expansion agent is present in an effective amount sufficient to produce a foam having a k-factor ranging from about 0.135 Btu·in/ft²·h·° F. to about 0.145 Btu·in/ft²·h·° F.

10. The foam expansion agent composition of claim 1, wherein the at least one high boiling point foam expansion agent is present in an effective amount sufficient to produce a foam having a k-factor of no greater than about 0.138 Btu·in/ft²·h·° F. at a temperature below 35° F.

11. The foam expansion agent composition of claim 1, wherein the at least one high boiling point foam expansion agent is present in an effective amount sufficient to produce a foam having a k-factor at least 0.005 Btu·in/ft²·h·° F. less than the k-factor of a foam produced using Z-1,1,1,4,4,4-hexafluoro-2-butene alone and a foam produced using the at least one high boiling point foam expansion agent alone.

12. The foam expansion agent composition of claim 11, wherein the at least one high boiling point foam expansion agent is present in an effective amount sufficient to produce a foam having a k-factor at least 0.010 Btu·in/ft²·h·° F. less than the k-factor of a foam produced using Z-1,1,1,4,4,4-hexafluoro-2-butene and a foam produced using the at least one high boiling point foam expansion agent alone.

13. A foam-forming composition comprising:
(a) the foam expansion agent composition of claim 1; and
(b) an active hydrogen-containing compound having two or more active hydrogens.

14. The foam-forming composition of claim 13, wherein said active hydrogen-containing compound is a polyol.

15. The foam-forming composition of claim 14, wherein said active hydrogen-containing compound is a polyether polyol.

16. The foam-forming composition of claim 13, wherein said at least one high boiling point foam expansion agent is chosen from methyl formate, pentane, isopentane, HFC-365mfc, trans-1,2-dichloroethylene, HFC-245fa, dimethoxymethane, cyclopentane, and combinations thereof.

17. The foam-forming composition of claim 16, wherein said at least one high boiling point foam expansion agent comprises cyclopentane.

18. The foam-forming composition of claim 17, wherein the at least one high boiling point foam expansion agent comprises about 5 wt. % to about 60 wt. % of the total foam expansion agent composition.

19. A closed-cell polyurethane or polyisocyanurate polymer foam prepared from reaction of an effective amount of the foam-forming composition of claim 13 with a suitable polyisocyanate.

20. The closed-cell polyurethane or polyisocyanurate polymer foam of claim 19, wherein said polymer foam has a k-factor of less than about 0.139 Btu·in/ft²·h·° F. at a temperature no greater than about 50° F.

21. The closed-cell polyurethane or polyisocyanurate polymer foam of claim 20, wherein said polymer foam has a k-factor no greater than about 0.139 Btu·in/ft²·h·° F. at a 35° F.

22. The closed-cell polyurethane or polyisocyanurate polymer foam of claim 19, wherein said at least one high boiling point foam expansion agent is chosen from methyl formate, pentane, isopentane, HFC-365mfc, trans-1,2-dichloroethylene, HFC-245fa, dimethoxymethane, cyclopentane, and combinations thereof.

23. The closed-cell polyurethane or polyisocyanurate polymer foam of claim 22, wherein said at least one high boiling point foam expansion agent comprises cyclopentane.

24. A process for producing a closed-cell polyurethane or polyisocyanurate polymer foam comprising: reacting an effective amount of the foam-forming composition of claim 13 with a suitable polyisocyanate.

25. The process for producing a closed-cell polyurethane or polyisocyanurate polymer foam of claim 24, wherein the at least one high boiling point foam expansion agent is chosen from methyl formate, pentane, isopentane, HFC-365mfc, trans-1,2-dichloroethylene, HFC-245fa, dimethoxymethane, cyclopentane, and combinations thereof.

26. The process for producing a closed-cell polyurethane or polyisocyanurate polymer foam of claim 25, wherein the at least one high boiling point foam expansion agent comprises cyclopentane.

27. The process for producing a closed-cell polyurethane or polyisocyanurate polymer foam of claim 26, wherein the cyclopentane is present in an amount ranging from about 5 wt. % to about 60 wt. % of the total weight of the foam expansion agent composition.
